(19) United States
(12) Patent Application Publication
(10) Pub. No.: US 2015/0296215 A1
(43) Pub. Date: Oct. 15, 2015

(54) FRAME ENCODING USING HINTS

(71) Applicant: MIcrosoft Corporation, Redmond, WA (US)

(72) Inventor: Sean Callahan, White Bear Lake, MN (US)

(73) Assignee: MIcrosoft Corporation, Redmond, WA (US)

(21) Appl. No.: 14/250,542

(22) Filed: Apr. 11, 2014

(51) Int. Cl. H04N 19/46; H04N 19/136; G06T 1/20

(52) U.S. Cl. CPC H04N 19/46; G06T 1/20; H04N 19/136

(57) ABSTRACT

Embodiments are directed to encoding frames in response to supplemental encoding instructions, to providing encoding information for frames and to compiling software code that includes encoding hints. In one embodiment, in response to accessing frame information associated with a frame, a computer system interprets the frame information as being a supplemental encoding instruction for encoding a specified portion of the frame. The computer system then encodes the frame so that the specified portion of the frame is encoded in accordance with the supplemental encoding instruction.

### BACKGROUND

Video data is routinely transmitted over networks such as the internet to consumers all over the world. The video data is generated by some type of software application. The video data is then transmitted to receiving system (i.e. clients) after being encoded by an encoder. The receiving systems then decode the encoded frames and display them to users. The video encoder typically encodes the frames sequentially as they are received from the software application. The encoder encodes the frames without any knowledge of the frame's actual content or without any idea of what is actually happening in the frame. The encoding process typically degrades the visual quality of the frames.

### BRIEF SUMMARY

Embodiments described herein are directed to encoding frames in response to supplemental encoding instructions, to providing encoding information for frames and to compiling software code that includes encoding hints. In one embodiment, in response to accessing frame information associated with a frame, a computer system interprets the frame information as being a supplemental encoding instruction for encoding a specified portion of the frame. The computer system then encodes the frame so that the specified portion of the frame is encoded in accordance with the supplemental encoding instruction.

In another embodiment, a computer system accesses frame information that corresponds to a frame. The computer system determines, from the accessed frame information, that at least one part of the frame is to be encoded in a specified manner. The computer system then generates a supplemental encoding instruction that identifies parts of the frame that are to be encoded in the specified manner and causes the supplemental encoding instruction to be provided to an encoder.

In yet another embodiment, a computer system receives an indication that specified portions of application content are to be encoded in a specified manner. The computer system adds application code to the application which indicates how the specified portions of application content are to be rendered and encoded. The computer system then compiles the application so that, when executed, the compiled application provides the information indicating how the specified portions of application content are to be encoded to a processor or to a second application that is configured to encode the application content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including encoding frames in response to supplemental encoding instructions.

FIG. 2 illustrates a flowchart of an example method for encoding frames in response to supplemental encoding instructions.

FIG. 3 illustrates a flowchart of an example method for providing encoding information for frames.

FIG. 4 illustrates a flowchart of an example method for compiling software code that includes encoding hints.

FIG. 5 illustrates a computing architecture in which frames are encoded according to frame information.

FIGS. 6A and 6B illustrate embodiments in which areas of interest are shown for different frames.

FIG. 7 illustrates an embodiment in which an area of interest is indicated for a heads-up display.

### DETAILED DESCRIPTION

Embodiments described herein are directed to encoding frames in response to supplemental encoding instructions, to providing encoding information for frames and to compiling software code that includes encoding hints. In one embodiment, in response to accessing frame information associated with a frame, a computer system interprets the frame information as being a supplemental encoding instruction for encoding a specified portion of the frame. The computer system then encodes the frame so that the specified portion of the frame is encoded in accordance with the supplemental encoding instruction.

In another embodiment, a computer system accesses frame information that corresponds to a frame. The computer system determines, from the accessed frame information, that at least one part of the frame is to be encoded in a specified manner. The computer system then generates a supplemental encoding instruction that identifies parts of the frame that are to be encoded in the specified manner and causes the supplemental encoding instruction to be provided to an encoder.

In yet another embodiment, a computer system receives an indication that specified portions of application content are to be encoded in a specified manner. The computer system adds application code to the application which indicates how the specified portions of application content are to be encoded. The computer system then compiles the application so that, when executed, the compiled application provides the information indicating how the specified portions of application content are to be encoded to a processor or to a second application that is configured to encode the application content.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

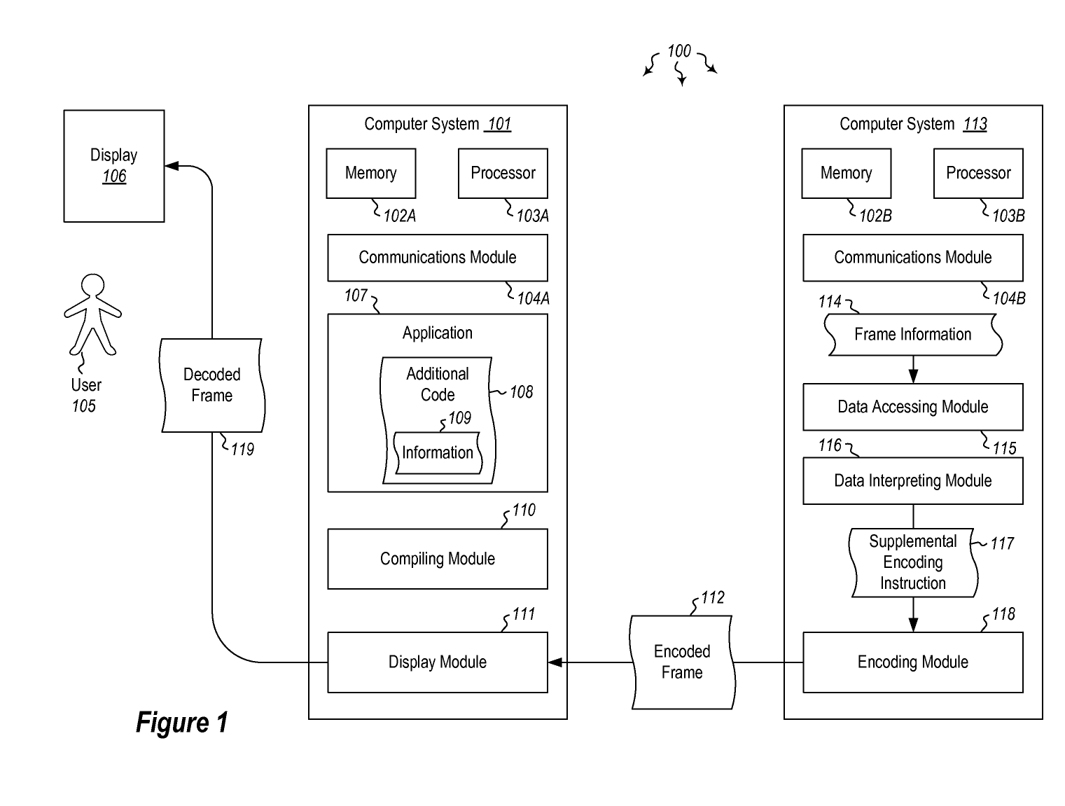

As illustrated in FIG. 1, a computing system 101 typically includes at least one processing unit 102A and memory 103A. The memory 103A may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103A of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103A. The system memory may also be referred to as “main memory”, and includes memory locations that are addressable by the at least one processing unit 102A over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer systems 101 and 113 may be any type of local or distributed computer systems, including cloud computing systems. Each includes at least one processor 102A/102B, memory 103A/103B and a communications module 104A/104B. The communications module may include wired or wireless communication means including wired or wireless network cards, Bluetooth wireless radios, WiFi radios or other hardware configured to transmit and/or receive digital data. The communications module 104A, for example, may receive encoded frames 112 from the communications module 104B of computer system 113.

In some embodiments, computer system 113 may be a server. The server may be a single computer system, or may be distributed. The server may be configured to provide data to clients such as computer system 101. The server may provide application data to clients in response to input or other requests for data (e.g. in response to input from user 105). In some cases, the computer system 113 may be a video game server. In such cases, the video game server may be configured to provide frames with video game content (e.g. encoded frame 112). These frames are typically encoded in some manner and the transferred in data packets. The frames may be sent in a continuous streaming manner in order to form a contiguous series of frames to form a motion picture. In the gaming scenario, this stream of frames would form a video game output. It should be understood that the video game embodiment, while referred to frequently herein, is merely one example among multiple possible embodiments where video content is transferred (i.e. streamed) from one computer system to another.

In many video games, the content of the video game is constantly changing. For example, in adventure games, a user may travel through many different worlds, each of which may have a different look and feel, each level having different enemies, scenery, etc. The same may be true for first-person shooter games, racing games, role playing games and other games. Each level may have different levels of detail, and may have changing levels of detail. Some levels may, for example, have a lower level of interactivity and may thus provide a higher level of visual quality. On the other hand, a level or part of a level may have a very high level of interactivity and may thus prioritize low latency over high quality graphics. In some situations, there may be certain areas of the screen or frame that may be of particular interest to a game player or other viewer. For example, if a user in a first person shooter game is aiming at a chosen target far away and shoots at the target, the user may wish to have additional detail given to the area around where the bullet hit. The user may be less focused on the rest of the screen, and may be more focused on that area. Such an area will be referred to as an “area of focus” or “area of interest” herein.

Video game (or other application) programmers may be able to provide hints as to where these areas of interest will be for a given game at a given time. For example, additional encoding bits may be assigned to areas of interest to provide a higher level of visual fidelity to that area (and perhaps to specified areas around the area of interest). The programmer may thus provide these hints in the game itself. The hints may then be provided to the encoder that ultimately encodes the video frames for the game. In this manner, the video game itself can provide game-specific areas of interest that hint to the encoder where additional bits of encoded video should be allocated. The programmer/video game can, for example, indicate parts of the screen where heads-up display (HUD) information should be readable at all times. The video game hints can thus indicate where on the screen the player is likely looking.

The hints can further provide an indication of what is currently happening on screen (i.e. within the video content). For example, the display may be currently fading to/from black/white. Additionally or alternatively, the screen may be currently split into multiple areas to support local multi-player, and those areas may be encoded separately, or with different encoding parameters or settings. Still further, the hints may indicate that a 3D camera is moving in a certain direction at a given rate. These are merely a few among many different examples of how the hinting information may provide an indication of what is currently happening on the user's screen.

The game hints may further provide an indication of a game's current interactivity state. For example, the game may be currently displaying non-interactive or low-interactivity content (e.g. pre-rendered video). In such scenarios, video quality is may be more important than latency. In highly interactive mode, low latency may be more important than high video quality. In other scenarios, the game may be in a moderate interactivity mode, such as when displaying a menu screen. In such cases, a programmer may provide hints as to whether video quality, latency or some other factor should receive encoding priority, or whether they should receive equal encoding priority.

In this manner, game-provided areas of interest may be passed to the encoder so it can encode those areas at a higher quality (with more bits) than the rest of the encoded frame. Prioritization may be applied in such a manner that more bits are given to the most important areas, some bits to less important areas, and the remaining bits to the remaining areas.

Fading hints may also be used to indicate to the encoder that weighted prediction should be used to compensate for and better-encode the fading video. Split screen information can be used to tell the encoder to not attempt to motion search across the split boundary and to encode blocks that straddle those boundaries with different settings than typical blocks. Camera motion information can be used to hint the encoder as to which direction it is most likely to find motion search matches, allowing it to find better matches more quickly.

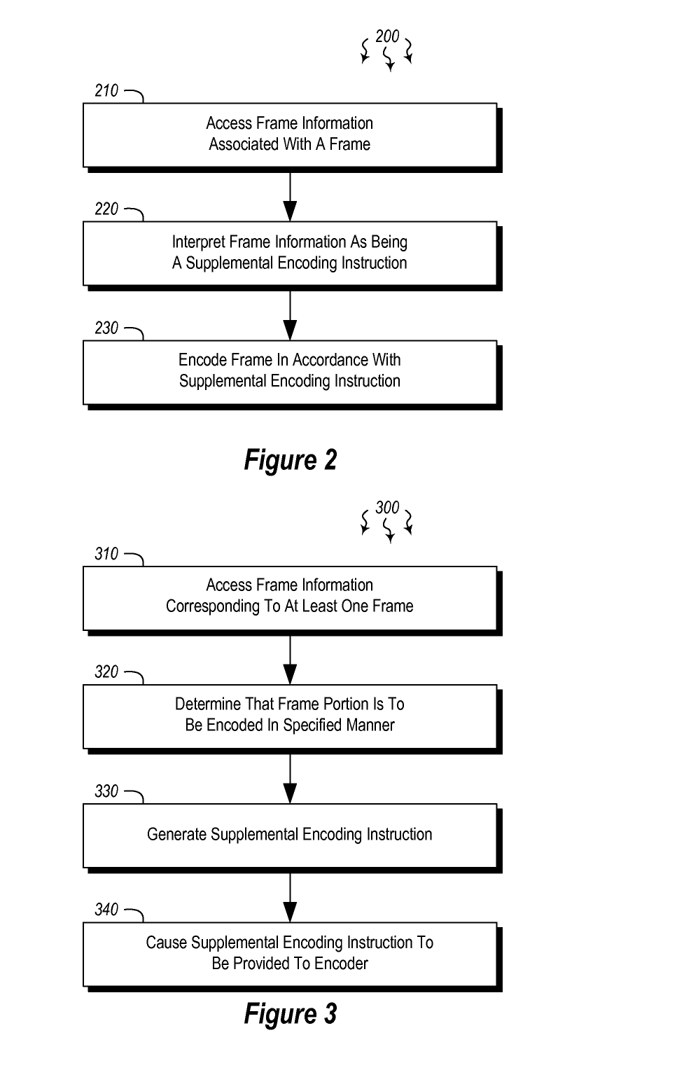

Interactivity state hints may also be used to bias video encode quality and specify the amount of buffering being used. Low-interactivity state allows for higher quality encoding (enabling Bi-directionally predicted frames, for example) and more buffering, providing smoother, higher quality video when the user is just watching and not interacting with the game. When the game is in high-interactivity state (during gameplay), encoding may be biased for lowest-possible latency, possibly at lower quality with less buffering. These concepts will be explained further below with regard to methods 200, 300 and 400 of FIGS. 2, 3 and 4, respectively.

In view of the systems and architectures described above, methodologies that may be implemented in accordance with the disclosed subject matter will be better appreciated with reference to the flow charts of FIGS. 2, 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for encoding frames in response to supplemental encoding instructions. The method 200 will now be described with frequent reference to the components and data of environment 100.

Method 200 includes an act of accessing one or more portions of frame information associated with at least one frame (act 210). This act may be performed by a processor, or may be performed by a computing system in conjunction with computer-readable media that stores computer-executable instructions for performing the accessing. The frame information may include hints about how certain parts of a frame or sequence of frames are to be encoded. For instance, as mentioned above, a developer may indicate certain areas of the frame as areas of interest. In such cases, these areas of interest may receive additional encoding bits so that the area of interest has a higher visual quality, lower latency, or both. The area of interest may also receive other types of processing, as designated by the developer. The data accessing module 115 of computer system 113 may receive the frame information 114 or may access it if it is stored in another location (e.g. perhaps on a database or other data store).

Method 200 next includes an act of interpreting the one or more portions of the frame information as being a supplemental encoding instruction for encoding at least one portion of the frame (act 220). The frame information 114 is interpreted by the data interpreting module 116 as being a supplemental encoding instruction 117 and is sent to the encoding module 118 for encoding. As used herein, a “supplemental encoding instruction” refers to an encoding instruction added by the frame information 114. The encoding module 118 will typically already be configured to encode frames in response to receiving information from a software application such as a video game. In such cases, a video game engine would provide video game content which would be encoded by the encoding module 118 and subsequently decoded into decoded frames 119 visible to the user 105 on display 106. In embodiments herein, encoding module 118 may also take into account the supplemental encoding instructions 117 provided through frame information (i.e. hints) 114. In this manner, a developer or other user may provide encoding hints that are supplemental to graphics information normally provided by an application. The encoding module 118 then encodes the frame 112 such that the portion (i.e. the area of interest) is encoded in accordance with the supplemental encoding instruction (act 230).

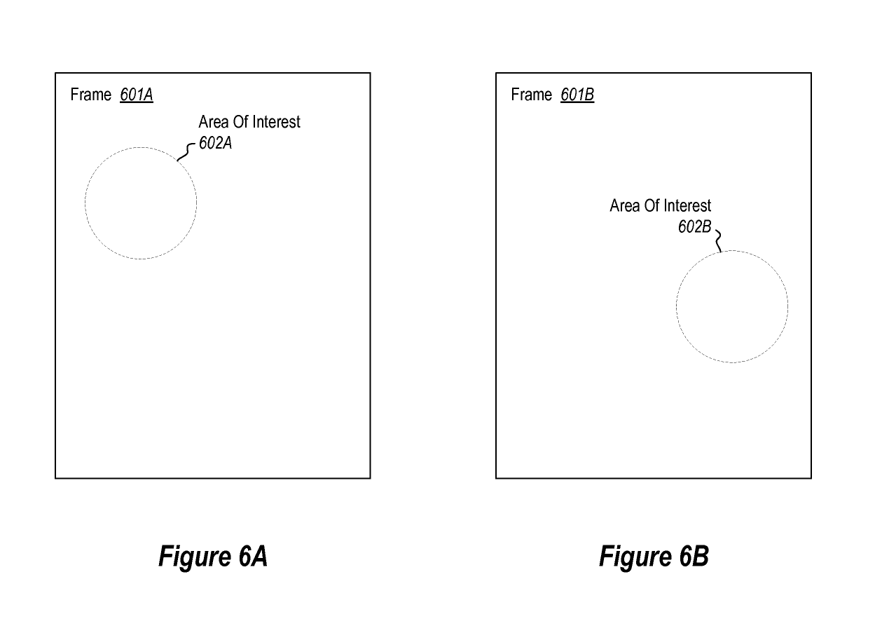

In some cases, the frame information 114 may affect the entire frame or an entire sequence of frames. In other cases, the frame information 114 may affect only portions of the frame or sequence of frames. This portion of the frame (i.e. area of interest) may change dynamically with each frame, according to the frame information 114 provided by the developer. For instance, as shown in FIGS. 6A and 6B, frame 601A may have area of interest 602A in the top left hand corner of the frame, while frame 601B may have the area of interest close to its center. In the case of a movie, this area of interest may be where a certain object has newly appeared on the screen, or where something is happening that is important for plot advancement, or where something is happening that provides added dramatic effect, or where the director would like the viewer to be focusing their attention. Indeed, the director, application developer or other user may dictate for each frame where the area of interest is to be, what size and shape the area is, whether there are multiple areas of interest in a single frame, what type of processing should occur in each area of interest in the frame, whether the area of interest should apply to a single frame or a series of frames, etc. As will be understood by one skilled in the art, the person causing the areas of interest to be applied to frames has the ability to customize and tailor the frame information for each frame or series of frames.

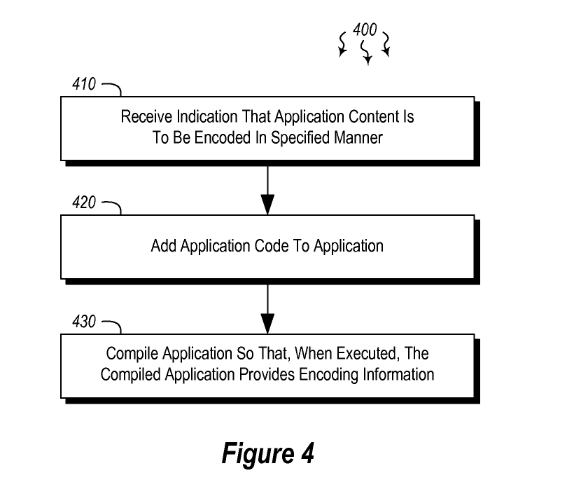

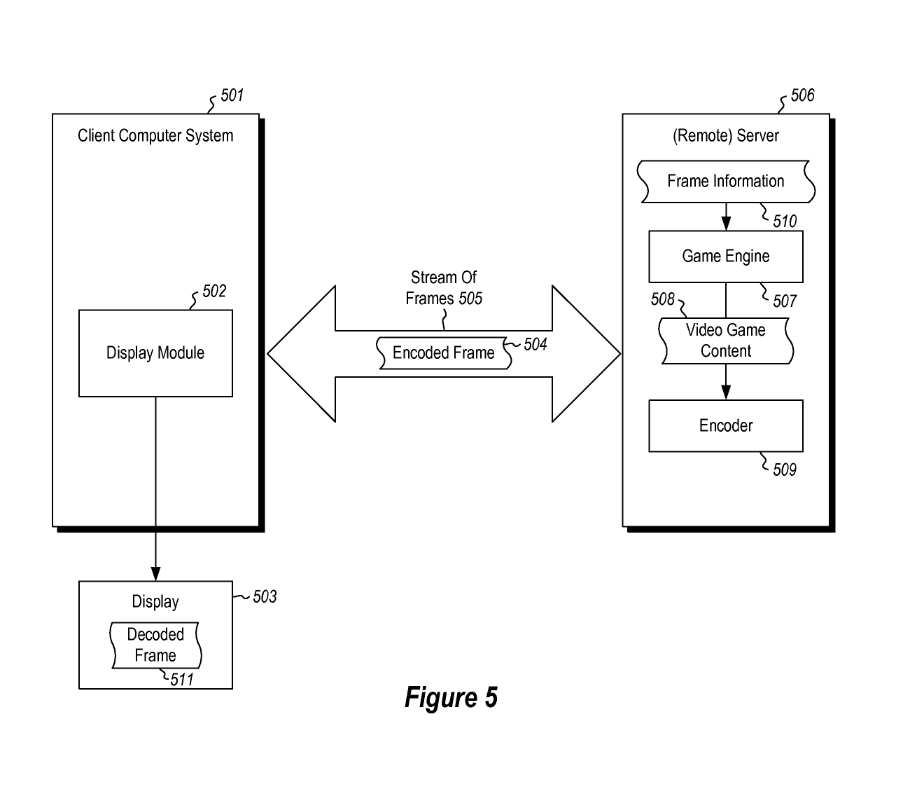

In some embodiments, as shown in FIG. 5, the frame information 114 of FIG. 1 may correspond to a frame of a video game. The video game may be a streamed video game streamed from server 506 (which may be a remote server). The server 506 may have a game engine 507 that processes video game code and generates video game content 508. This video game content 508 is sent to an encoder 509 (or to multiple encoders) where the video game content is encoded as a single frame 504 within a stream of frames 505. This stream of frames 505 may be transmitted over a wired or wireless network (e.g. over WiFi or the internet) to a client computer system 501. The client computer system 501 may include a display module 502 (which may be the same as or different than display module 111 of FIG. 1) that receives the encoded frames, potentially performs some type of processing on the frames (e.g. decoding), and sends the decoded frames 511 to display 503 for display to the viewer/player. Video game developers may provide frame information 114 to the game engine 507 via additional code that is provided within the game application code (this will be explained further below with regard to Method 400 of FIG. 4.

Thus, in a video game context, a video game developer can provide hints (i.e. frame information 114) as to which portions of the frame should receive extra (or a different type of) encoding bits. In this manner, the game author can identify areas of interest to provide a more accurate rendering, while simultaneously saving time during encoding as no image analysis needed to find areas of interest. The frame information may also provide more general indications of video game context for a given frame. For example, the video game author may indicate that snow is falling for a certain sequence of frames or for a certain level in a game. The video game author may add frame information 114 which is interpreted by the encoding module 118 as a supplemental encoding instruction that indicates that multiple portions of the frame will be changing in a random pattern to show snowflakes falling. Alternatively, the video game author may indicate that a sequence of frames is fading from the frames' regular coloring to an all-white or all-black screen. In such cases, many of the video game objects remain stationary, while only the coloring changes from multi-colored to white or black. This may allow the encoder to prioritize higher quality over lower latency during the fading sequence.

Many other types of video game context may be provided to generally assist the encoder in encoding certain frames of sequences of frames. For example, the frame information 114 may indicate that the camera view within a game (or other application) is moving in a certain direction or pattern (e.g. from right to left, left to right, top to bottom or bottom to top, diagonally, etc.). The camera view information may allow the encoder to know which portions of the frame are merely being shifted one direction or other, as opposed to be entirely new. In some cases, the camera may be 3D camera and, as such, the frame information 114 may include depth information (z-axis) as well as x-axis and y-axis information. This video context frame information may be in addition to or as an alternative to frame information that specifies areas of interest.

The areas of interest may be the same for a given level, for a given scene, for a given in-game video, for a certain sequence of gameplay, for a certain combination of elements (e.g. certain weapons with certain backgrounds or enemies, etc.) or may be specific to other elements as specified by the provider of the frame information 114. The frame information may indicate that an initial area of interest is to be defined for a portion of the frame 112/504, and that the area of interest will change over time. For example, the area of interest may change dynamically over time, corresponding to changes in the video game content. As indicated above, the game developer may indicate which video game content changes trigger the change in area of interest. Racing games, for example, may specify that additional encoding bits are to be assigned to areas on the screen where a wreck has occurred, or where tires are screeching or where outside walls are hit, or in other situations as defined by the developer. Role-playing games may specify that additional encoding bits are to be used in areas around the player (e.g. a hero) and around the enemy (e.g. an end-level boss) or around other in-game objects. The area of interest may thus change for each encoded frame if so designated by the game developer.

Some games offer a split-screen mode where one player play in the top screen and one player plays in the bottom screen when split horizontally (or in left and right screens if split vertically). In such cases, frame information 114 may be provided for each level of the split screen. That is, each split level may have its own points of interest and its own frame information (i.e. hints) describing how encoding bits are to be distributed among the various portions of the frame. For example, in a racing game in split-screen mode, the player on the top screen may be running out of gas and, as such, the game may be flashing or blinking around the fuel area. The developer may indicate that this is likely an area of interest for that user and so the user on the top screen would have an area of interest around the gas gauge (potentially among other places on the screen). The player on the bottom screen may have plenty of gas, but may have gotten in a wreck, and thus may need more encoding bits for encoding the screen changes used to depict the wreck. Additional encoding bits may be distributed evenly among the top and bottom split screens, or may be assigned dynamically. Thus, if one split screen has very little going on, and the other has more going on, more bits may be assigned to the latter split screen. If game or application content changes so that the other split screen has more activity, the allocation of encoding bits may change accordingly to provide each split screen an optimal frame encoding quality.

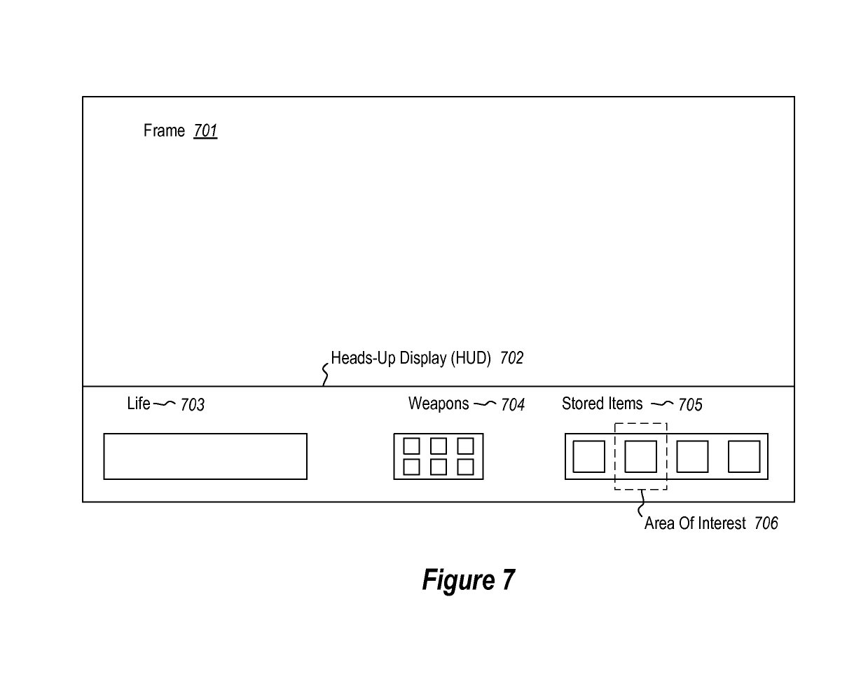

As shown in FIG. 7, the frame information 114 from FIG. 1 may be used to specify portions of heads-up display (HUD) information that are to be enhanced. For instance, in frame 701, the heads-up display 702 may include a life meter 703, a weapons indicator 704 and a stored items indicator 705. The game player may be playing a game where the player acquires an object that is stored in the stored items indicator 705. That object may be blinking or may temporarily grow in size, or may stand out in some other way. The game's developer may indicate that an area of interest 706 exists around the stored item, and that the stored area is to receive additional encoding bits. As above, the game developer is able to specify any one or more areas of the HUD as areas of interest, and the areas of interest on the HUD may change over time and/or may change for each frame. Thus, in this manner, whether the area of interest is on an area of the HUD, or in another portion of the frame, the game developer may provide frame information 114 to indicate where on the frame a viewer is likeliest to be looking at a given moment, and cause additional processing to be performed to those areas.

Turning now to FIG. 3, a flowchart is illustrated of a method 300 for providing encoding information for frames. The method 300 will now be described with frequent reference to the components and data of environment 100.

Method 300 includes an act of accessing one or more portions of frame information that corresponds to at least one frame (act 310). For example, the data accessing module 115 of FIG. 1 may access frame information 114 which corresponds to one or more encoded frames 112 that include application content. The data interpreting module 116 may determine, from the accessed frame information, that at least one portion of the frame is to be encoded in a specified manner (act 320). For example, as mentioned above, a developer or other user may be able to specify how a frame (or portions thereof) is to be encoded. The developer may specify areas of interest, and may specify certain encoding methods or encoding prioritizations for those areas of interest. In this way, the frame is encoded in the manner specified by the developer. The data interpreting module 116 (or another module) within computer system 113 may generate a supplemental encoding instruction that identifies one or more portions of the frame that are to be encoded in the specified manner (act 330) and then cause the supplemental encoding instruction to be provided to an encoder (act 340). Thus, the supplemental encoding instruction 117 may be sent to encoding module 118 (which may itself be an encoder or may include an encoder as part of the module) where the frame is encoded and passed to computer system 101. The display module 111 of computer system 101 may then decode the encoded frame(s) for display on display 106.

In some cases, the computer system 1113 may determine an interactivity state for an application to which the frame corresponds. For example, the computer system 113 may determine whether there is currently a large amount of interactivity (e.g. the user 105 is currently pressing buttons and/or controlling joysticks, etc.) or whether there is currently a small amount of interactivity (such as during a movie). Once the interactivity state has been determined relative to a given frame, the supplemental encoding instruction may be altered. For instance, the supplemental encoding instruction may indicate an area of interest on a frame (e.g. 602A in frame 601 of FIG. 6A). The interactivity state may be determined to be highly active and, as such, the area of interest may be reduced in size, or the number of additional encoding bits may be increased to accommodate for the determined highly interactive state. Similarly, if the interactivity state is determined to be low, the area of interest may be increased in size, or the number of additional encoding bits may be decreased in line with the determined lower interactive state. As such, the supplemental encoding instruction may be altered according to a determined current interactivity state.

Still further, the supplemental encoding instruction itself may be dependent on a determined interactivity state. In such cases, a developer may indicate that the number of areas of interest can vary with interactivity, or the size can vary with interactivity, etc. In some cases, if an application (such as a video game) is determined to currently be in a high interactivity state, low-latency encoding may be prioritized over higher quality encoding. Moreover, if an application is determined to be in a low interactivity state, higher quality encoding may be prioritized over low-latency encoding. Different encoding techniques or different application of encoding bits may also be used for high-interactivity or low-interactivity scenarios. In this manner, a developer may be able to specify that supplemental encoding instructions 117 may be changed or may be dependent on a determined level of interaction with the application. Developers may add the frame information 114 (i.e. hints) to an application as shown below with regard to FIG. 4.

FIG. 4 illustrates a flowchart of a method 400 for compiling software code that includes encoding hints. The method 400 will now be described with frequent reference to the components and data of environment 100.

Method 400 includes an act of receiving an indication that one or more portions of application content are to be encoded in a specified manner (act 410). For example, a developer or other user 105 may indicate that various areas of interest on a frame are to be encoded in a manner specified by the user. The user may provide this indication to computer system 101 via input from that user. The computer system then adds application code 108 to the application 107, where the added application code includes information 109 indicating how the specified portions of application content are to be encoded (act 420). This information 109 may be similar to or the same as the frame information 114 ultimately provided to the data accessing module 115. The compiling module 110 of computer system 101 may then compile the application such that, when executed, the compiled application provides the information 109 indicating how the specified portions of application content are to be encoded to a processor or to a second application that is configured to encode the application content (act 430).

The information 109 provided by the user 105 may be hints indicating how certain portions of frame content are to be encoded. This hint information may be integrated into the application's code (e.g. into a video game's code) so that when another application (e.g. game engine 507) or another processor (e.g. 103B of computer system 113) accesses the game code, the hinting information 109 is already part of the game code. Then, the game engine can access the frame information and encode the video game (or other application content) frames in the manner specified by the developer. The developer may specify that various portions of application content are to be changed dynamically based on video game content, based on certain things that are occurring within the frame (e.g. certain camera movements, or certain characters or certain moves, etc.) or based on other factors. The developer may specify which areas of the screen are most likely being viewed at that point in the game, movie or application, and which should receive additional and/or different types of processing.

Accordingly, methods, systems and computer program products are provided which encode frames in response to supplemental encoding instructions. Moreover, methods, systems and computer program products are provided which provide encoding information for frames and compile software code that includes encoding hints.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A method comprising:
an act of accessing a user selection of a visualization type;
an act of accessing a user selection of a subset of data from a data model;
an act of evaluating the user selections of the visualization type and the subset of data against a rule set that defines sufficiency of data for the selected visualization type; and
based on the evaluation, an act of determining that the subset of data does not populate or insufficiently populates the visualization type.

2. A method in accordance with claim 1, further comprising:
an act of displaying a visualization of the selected visualization type using the selected subset of data from the data model.

3. A method in accordance with claim 1, further comprising:
an act of recommending one or more additional data sets from the data model that would, according to the rule set, be more sufficient to populate the selected visualization type.

4. A method in accordance with claim 3, further comprising:
an act of detecting a user selection of at least one of the one or more recommended additional data sets.

5. A method in accordance with claim 4, further comprising:
an act of displaying a visualization of the selected visualization type using the selected subset of data from the model, and using the at least one recommended additional data set.

6. A method in accordance with claim 1, the data model being an authored data model.

7. A method in accordance with claim 6, the authored data model further being expanded with auxiliary information not originally within the authored data model.

8. A method in accordance with claim 1, the rule set defining sufficiency data for each of a plurality of visualization types.

9. A method in accordance with claim 8, the user selection of the visualization type being a first user selection of a first visualization type, the user selection of the subset of data being a first user selection of a first subset of the data, and the comparison being a first comparison, the method further comprising:
an act of accessing a second user selection of a second visualization type;
an act of accessing a second user selection of a second subset of data from the data model;
an act of evaluating the second user selection of the second visualization type and the second selection of the second subset of data against the rule set using sufficiency of data for the second visualization type; and
based on the second comparison, an act of determining that the second subset of data does not populate or “insufficiently populates” the second visualization type.

10. A method in accordance with claim 9, the second subset of data being the same as the first subset of data.

11. A method in accordance with claim 10, the method further comprising:
an act of displaying a visualization of the first selected visualization type using the first selected subset of data from the data model,
the act of accessing a second user selection of the second visualization type comprising:
an act of accessing a user request to switch from the first visualization type to the second visualization type at some point.

12. A method in accordance with claim 1, wherein the subset of data does not populate the visualization type.

13. A method in accordance with claim 1, wherein the subset of insufficiently populates the visualization type.

14. A computer program product comprising one or more computer-readable storage media having thereon one or more computer-executable instructions that are structured such that, when executed by one or more processors of the computing system, cause the computing system respond to a user selection of a visualization and a user selection of a subset of data from the data model by performing the following:
an act of accessing a rule set that defines sufficiency of data for the selected visualization;
an act of evaluating the user selections of the visualization type and the subset of data against the rule set;
based on the evaluation, an act of determining that the subset of data does not populate or insufficiently populates the visualization type; and
an act of displaying a visualization of the visualization type.

15. A computer program product in accordance with claim 14, the visualization type being a scatter plot.

16. A computer program product in accordance with claim 14, the visualization type being a geographic visualization.

17. A computer program product in accordance with claim 14, the visualization type being a bar chart.

18. A computer program product in accordance with claim 14, the visualization type being a timeline.

19. A computer program product in accordance with claim 14, the visualization type being a pie chart.
method in accordance with claim 1, further comprising:
an act of displaying a visualization of the selected visualization type using the selected subset of data from the data model.

20. A computer program product comprising one or more computer-readable storage media having thereon one or more computer-executable instructions that are structured such that, when executed by one or more processors of the computing system, cause the computing system respond to a user selection of a visualization and a user selection of a subset of data from the data model by performing the following:
an act of accessing a rule set that defines sufficiency of data for the selected visualization;
an act of evaluating the user selections of the visualization type and the subset of data against the rule set;
based on the evaluation, an act of determining that the subset of data does not populate or insufficiently populates the visualization type;
an act of recommending one or more additional data sets from the data model that would, according to the rule set, be more sufficient to populate the selected visualization type; and.
in response to detecting a user selection of at least one of the one or more recommended data sets, an act of displaying a visualization of the selected visualization type using the selected subset of data from the model, and using the at least one recommended additional data set.

21. A computer-implemented method performed by one or more processors of a computing system which includes a memory containing computer-executable instructions which, when executed, cause the one or more processors to perform the computer-implemented method, and wherein the computer-implemented method is used to control encoding frames of video data so that areas of interest in one or more frames are displayed more effectively, and wherein the computer-implemented method comprises:
the one or more processors initiating a data accessing module and accessing one or more portions of frame information associated with at least one frame from a stream of video data, and at least one of the one or more portions of the frame information containing hint information which is used to indicate a need for a supplemental encoding instruction for an area of interest in the frame information;
the one or more processors initiating a data interpreting module which interprets the hint information;
the one or more processors then generating a supplemental encoding instruction for the interpreted hint information so that the area of interest in the frame information will be encoded in accordance with the supplemental encoding instruction;
the one or more processors initiating an encoding module that encodes the area of interest in accordance with the supplemental encoding instruction; and
the encoding module sending the frame information as encoded to a display module for output.
